(19) United States
(12) Patent Application Publication
(10) Pub. No.: US 2015/0248127 A1
(43) Pub. Date: Sep. 3, 2015

(54) PROCESS MANAGEMENT SYSTEMS USING COMPARISON OF STATISTICAL DATA TO PROCESS PARAMETERS AND PROCESS MANAGEMENT DEVICES

(71) Applicant: Samsung Electronics Co., Ltd., Suwon-si (KR)

(72) Inventors: Yu Sin Yang, Seoul (KR); Young Hoon Sohn, Incheon (KR); Bae Jin Lee, Hwaseong-si (KR); Sang Kil Lee, Yongin-si (KR); Chung Sam Jun, Suwon-si (KR)

(21) Appl. No.: 14/635,193

(22) Filed: Mar. 2, 2015

(30) Foreign Application Priority Data
Mar. 3, 2014 (KR) 10-2014-0025179

(51) Int. Cl. G05B 19/418

(52) U.S. Cl. CPC G05B 19/418; G05B 2219/45031

(57) ABSTRACT

A process management system can include a processing device that can be configured to perform a semiconductor process on a plurality of wafers, the processing device controlled by a process parameter. A control device can be configured to acquire statistical data relating to the process parameter and can be configured to select a reference wafer from the plurality of wafers. The control device can be configured to compare a respective process parameter used for the reference wafer with the statistical data and can be configured to set a reference condition for the process parameter.

### CROSS-REFERENCE TO RELATED APPLICATION

This application claims the benefit of Korean Patent Application No. 10-2014-0025179 filed on Mar. 3, 2014, with the Korean Intellectual Property Office, the disclosure of which is incorporated herein by reference.

### BACKGROUND

The present disclosure relates to process management systems and process management devices.

As the miniaturization of semiconductors (for example, semiconductors having a size of 30 nm or below) has progressed, it has become increasingly important to control the degree of scattering of process parameters applied to respective processes for manufacturing semiconductor devices. By directly measuring the critical dimension (CD) (or the like) of a wafer manufactured as a final product through one or more processes, the degree of scattering of process parameters applied to the processes may be controlled. However, in practice, as it may be difficult or impractical to inspect all wafers manufactured in a process, virtual metrology methods have been introduced. General virtual metrology methods commonly use a method of measuring the degree of scattering of process parameters and determining whether or not process parameter control is satisfactory, for each process.

### SUMMARY

According to an aspect of the present disclosure, a process management system can include a processing device that can be configured to perform a semiconductor process on a plurality of wafers, the processing device controlled by a process parameter. A control device can be configured to acquire statistical data relating to the process parameter and can be configured to select a reference wafer from the plurality of wafers. The control device can be configured to compare a respective process parameter used for the reference wafer with the statistical data and can be configured to set a reference condition for the process parameter.

According to an aspect of the present disclosure, a process management device may include: a communications unit connected to a plurality of processing devices performing semiconductor processes controlled by process parameters on a plurality of wafers; and a calculation unit configured to calculate statistical data relating to the process parameters by acquiring the process parameters through the communication unit, and select a wafer having a yield rate higher than a reference yield rate from among the plurality of wafers as a reference wafer, wherein the calculation unit may compare the process parameters applied to the reference wafer with the statistical data relating to the process parameters to set reference conditions of the process parameters.

In some embodiments, a semiconductor process management system can include a semiconductor process control device configured to select a reference wafer from among a plurality of semiconductor wafers fabricated using a semiconductor processing device included in a semiconductor process used to fabricate the plurality of semiconductor wafers, wherein the semiconductor process control device is configured to select the reference wafer based on statistical data gathered on a range of semiconductor process parameter values. The semiconductor processing device can have a respective semiconductor process parameter that varies over a range of values in fabricating the plurality of semiconductor wafers. The semiconductor process control device can be configured to compare a value of the semiconductor process parameter used to fabricate the reference wafer to the statistical data associated with the range of values of the semiconductor process parameter values to set a reference value of the semiconductor process parameter value.

### BRIEF DESCRIPTION OF DRAWINGS

The above and other aspects, features and advantages will be more clearly understood from the following detailed description taken in conjunction with the accompanying drawings, in which:

FIG. 1 is a schematic block diagram of a process management system according to exemplary embodiments of the present disclosure;

FIG. 2 is a schematic block diagram illustrating the configuration of a process management device according to exemplary embodiments of the present disclosure;

FIGS. 3 through 5 are flowcharts illustrating the operations of a process management system according to exemplary embodiments of the present disclosure;

FIGS. 6A through 6I are cross-sectional views illustrating semiconductor processes that may be managed by a process management system according to exemplary embodiments of the present disclosure;

FIG. 7 includes graphs illustrating the operations of a process management system according to exemplary embodiments of the present disclosure;

FIG. 8 is a diagram of a system and corresponding graphs illustrating a process management system according to exemplary embodiments of the present disclosure;

FIGS. 9 and 10 are flowcharts illustrating the operations of a process management system according to exemplary embodiments of the present disclosure; and

FIGS. 11 and 12 are views illustrating the operations of a process management system according to exemplary embodiments of the present disclosure.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, primary, second, secondary etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, circuits and articles of manufacture including computer readable code according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor or controller circuit of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It will be understood that, in some embodiments according to the invention, the control device 20 may be located remote from the processing devices, such as over a network. Furthermore, the control device 20 may be located in a separate facility or building relative to the processing devices. Still further, the control device 20 and the processing devices may be under the control of different entities. For example, the processing devices may be under control of a semiconductor manufacturer, whereas the control device 20 may be under control of a contractor or service provider that is separate from the semiconductor manufacturer. Accordingly, the contractor or service provider may operate the control device 20 (coupled to the remote processing devices) to manage the process for the semiconductor manufacturer as described herein. Further, some of the operations described herein may be carried out by separate entities operating at different locations.

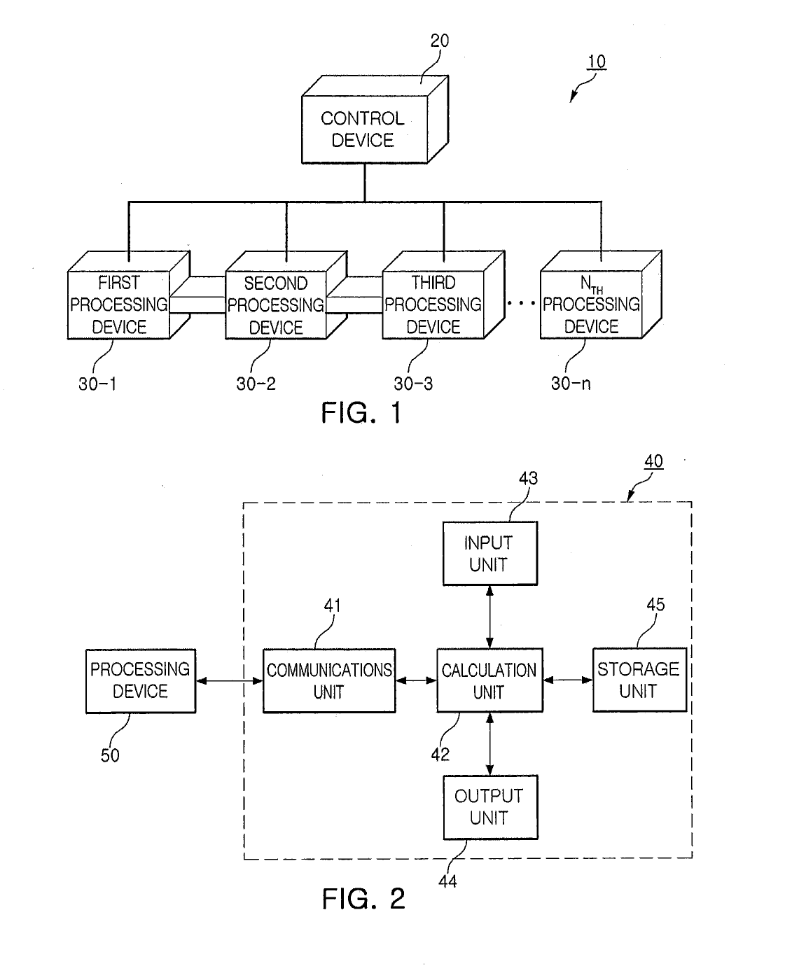

FIG. 1 is a schematic block diagram of a process management system according to exemplary embodiments of the present disclosure.

With reference to FIG. 1, a process management system 10 according to exemplary embodiments of the present disclosure may include n number of processing devices 30-1 to 30-n in total, and a control device 20 controlling the operations of the processing devices 30-1 to 30-n. The control device 2Q may be connected to and communicate with the processing devices 30-1 to 30-n, and may include an input/output unit enabling users managing processes to monitor each of the processing devices 30-1 to 30-n and allowing the processing devices 30-1 to 30-n to control process parameters used to form a wafer, and a storage unit configured to store data relating to process parameters acquired from the processing devices 30-1 to 30-n, wafer characteristics, and the like.

The control device 20 may be a computer apparatus having the input/output unit, a communication unit, a storing unit, a display unit, and so on. The input/output unit, the communication unit, the storing unit, and the display unit may be implemented as hardware.

Here, the processing devices 30-1 to 30-n may be connected to each other, such that a wafer, a processing object, may be sequentially processed by being passed from a first processing device 30-1 to each of the successive processing devices 30-n. In other words, the wafer may be subject to n processes, from a first process to an nth process.

According to exemplary embodiments of the present disclosure, at least some of the processing devices 30-1 to 30-n may include sensors configured to measure wafer characteristic values before and/or after each process. The wafer characteristic values measured by the sensors may be transferred to the control device 20. The control device 20 may determine a yield rate of wafers manufactured by each process and the total process, and may control the operations of the processing devices 30-1 to 30-n in a case in which fluctuations in the production yield rate occur at a rate higher than a standard level.

The processing devices 30-1 to 30-n may perform at least one of a photo process, an etching process, a washing process, a deposition process and a polishing process on the wafer being processed. In other words, the n number of processing devices 30-1 to 30-n may perform semiconductor processes on the wafer. The semiconductor processes performed by the processing devices 30-1 to 30-n may be controlled depending on predetermined process parameters, and the process parameters may be controlled by the control device 20. The process parameters may include parameters for controlling respective semiconductor processes, data detected by a fault detection and classification (FDC) sensor, an optical emission spectroscopy (OES) sensor, or the like.

According to exemplary embodiments of the present disclosure, a photo process may include coating a photo resist (PR) material on a wafer and baking a wafer at a high temperature. Here, the baking temperature, the PR coating speed in a spin coating process of the PR, and the like, may be examples of process parameters influencing the yield rate. In a specific example, the PR coating speed is expressed as RPM (revolutions per minutes). The control device 20 may select the baking temperature, the PR coating speed, and the like, as the process parameters for some of the processing devices 30-1 to 30-n performing the photo process on the wafer. For some of the processing devices 30-1 to 30-n performing a deposition process on the wafer, a gas flow amount, a chuck temperature, a chamber temperature and the like may be selected as the process parameters. According to exemplary embodiments of the present disclosure, the chuck temperature, a temperature of a chuck on which the wafer is loaded, may be measured by a chuck temperature measuring jig.

The control device 20 may acquire statistical data relating to corresponding process parameters applied to the processing devices 30-1 to 30-n, respectively. For example, in a case in which m wafers are manufactured by the process management system 10, baking temperatures applied to the m wafers in the baking process may be collected, and an average value and the degree of scattering of the collected baking temperatures may be calculated to acquire statistical data relating to the baking temperature as a process parameter. The control device 20 may acquire statistical data relating to other process parameters including the PR coating speed, OES data generated during an etching process, the film coating speed for controlling a film coating process, or the like, in a similar manner. In exemplary embodiments of the present disclosure, the control device 20 may acquire statistical data relating to one or more process parameters for each processing devices 30-1 to 30-n.

Meanwhile, in addition to the process parameters, the control device 20 may acquire the wafer characteristic values from the wafer processed by the processing devices 30-1 to 30-n, and may generate statistical data relating to the acquired wafer characteristic values. As described above, at least some of the processing devices 30-1 to 30-n may include sensors for measuring wafer characteristics. According to exemplary embodiments of the present disclosure, a photo processing device may include a sensor configured to measure leveling data relating to the level control characteristics of a wafer to which a photo process has been applied, and a deposition processing device may include an optical spectrum sensor configured to measure the optical spectrum characteristics of a wafer to which a deposition process has been applied. In other words, the control device 20 may receive the wafer characteristic values from the sensors included in at least some of the processing devices 30-1 to 30-n, and may acquire statistical data relating to the received characteristic values.

The control device 20 may select a reference wafer having a good yield rate among the m number of wafers introduced into the process management system 10. The yield rate is decided according to the rate of semiconductor chips satisfying predetermined requirements among a plurality of semiconductor chips manufactured on a wafer. The reference wafer may be a wafer having a yield rate greater than a reference yield rate. Here, the reference yield rate may be a value preset by a process manager. Among the m wafers, a wafer having the highest production yield rate, or two or more wafers having a production yield rate that is greater than the reference yield rate may be selected as the reference wafer.

The control device 20 may compare process parameters applied to the selected reference wafer with statistical data relating to respective process parameters to thereby set reference conditions for the corresponding process parameters. The control device 20 may compare a process parameter applied to the reference wafer with the statistical data relating to the corresponding process parameter to thereby assign an eigenvalue to the corresponding process parameter applied to the reference wafer. By using the above-described method, the control device 20 may assign eigenvalues to the process parameters applied to the reference wafer and may set a group of assigned eigenvalues as the reference conditions of the overall process management system 10.

FIG. 2 is a schematic block diagram illustrating the configuration of a process management device according to exemplary embodiments of the present disclosure.

With reference to FIG. 2, a process management device 40 according to exemplary embodiments of the present disclosure may include a communications unit 41, a calculation unit 42, an input unit 43, an output unit 44, and a storage unit 45. The term “unit” can refer to a hardware and software sub-system. The process management device 40 may be connected to a processing device 50 performing at least one semiconductor process on a plurality of wafers to be able to communicate with the processing device 50 through the communications unit 41. Two or more processing devices 50 may be connected to the communications unit 41. The process management device 40 may be a computer and may include the input unit 43 and the output unit 44 allowing a process manager to manage the processes and monitor progress of the processes. Each of units 41 to 45 included in the process management device 40 can be implemented as a hardware device or a combination of hardware and software.

The processing device 50 may be one of the processing devices 30-1 to 30-n as illustrated in FIG. 1, or may be a module executing a plurality of processes for forming a predetermined area of a specific semiconductor device. In exemplary embodiments of the present disclosure, the processing device 50 may be a module executing processes for forming an active element such as a transistor in manufacturing a dynamic random access memory (DRAM).

The overall operations of the process management device 40 may be controlled by the calculation unit 42. The calculation unit 42 may acquire process parameters for controlling a semiconductor process performed by the processing device 50 through the communications unit 41. In exemplary embodiments of the present disclosure, in a case in which the processing device 50 is a deposition processing device, the calculation unit 42 may set a gas flow amount for film deposition, a chuck temperature, or the like, as process parameters and may receive data relating to respective process parameters from the processing device 50.

Meanwhile, the processing device 50 may include a sensor configured to detect a wafer characteristic value before a wafer is introduced into the processing device 50 to be processed in a semiconductor process and after the semiconductor process is applied to the wafer. The calculation unit 42 may receive the wafer characteristic value detected by the sensor from the communications unit 41, and may acquire statistical data relating to wafer characteristic values for a plurality of wafers, respectively. In exemplary embodiments of the present disclosure, in a case in which the processing device 50 is a deposition processing device, the calculation unit 42 may receive data relating to optical reflection spectrum detected by an optical spectrum sensor as a wafer characteristic value.

That is, the calculation unit 42 may acquire statistical data relating to the process parameters in the semiconductor process executed by the processing device 50 and the wafer characteristic values of the wafers to which the semiconductor process has been applied. In the case of the deposition processing device, the calculation unit 42 may acquire the statistical data relating to the process parameters such as a gas flow amount, the rate of the gas flow, a chuck temperature, a pressure, or the like, and the statistical data relating to the optical reflection spectrum detected by the sensor. In a case in which the processing device 50 is a photo processing device, the calculation unit 42 may acquire statistical data relating to process parameters such as a PR coating speed for coating a photo resist material, a light exposure time, or the like, and statistical data relating to focus leveling data or the like detected by the sensor.

Meanwhile, the calculation unit 42 may select a reference wafer having a yield rate greater than a predetermined reference yield rate among wafers on which a semiconductor process has been performed by the processing device 50. Yield rates of all of the wafers passing through the processing device 50 may be tested. Here, the calculation unit 42 may receive test results regarding the yield rates of all of the wafers through the communications unit 41 and select the reference wafer having a yield rate that is greater than the reference yield rate. The calculation unit 42 may compare process parameters applied to the reference wafer and wafer characteristic values of the reference wafer with the statistical data acquired in advance, and may assign eigenvalues to the process parameters and the wafer characteristic values, respectively.

In the case in which the processing device 50 is the deposition processing device as described above, the calculation unit 42 may acquire the statistical data relating to the process parameters such as the gas flow amount, the chuck temperature, or the like, and the statistical data relating to the optical reflection spectrum detected by the sensor, and may store the acquired statistical data in the storage unit 45. When the reference wafer is selected, the calculation unit 42 may compare a gas flow amount and a chuck temperature applied to the reference wafer with the statistical data relating to the gas flow amount and the statistical data relating to the chuck temperature, respectively. Likewise, the calculation unit 42 may compare an optical reflection spectrum value of the reference wafer with the statistical data relating to the optical reflection spectrum.

In exemplary embodiments of the present disclosure, the statistical data relating to the process parameters and the wafer characteristic values may be expressed as normal distribution functions having average values and degrees of scattering. The normal distribution function representing the statistical data may be divided into a plurality of ranges according to the degree of scattering based on the average value. The calculation unit 42 may assign eigenvalues to a process parameter and a wafer characteristic value, depending on a range to which the corresponding process parameter applied to the reference wafer and the corresponding wafer characteristic value of the reference wafer belong, among the plurality of ranges of the statistical data. When the eigenvalues are assigned to the corresponding process parameters and the corresponding wafer characteristic values, respectively, the calculation unit 42 may set a group of the eigenvalues as reference conditions.

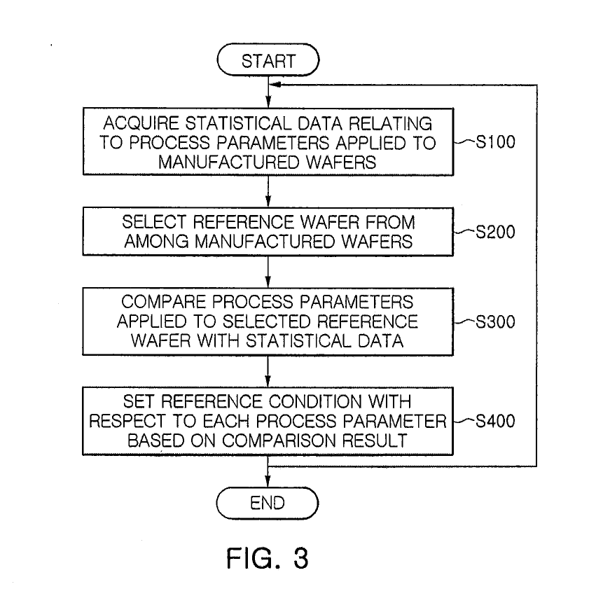

Methods of selecting a reference wafer and setting reference conditions using the selected reference wafer will be described in detail with reference to flowcharts illustrated in FIGS. 3 through 5.

FIGS. 3 through 5 are flowcharts illustrating the operations of a process management system according to exemplary embodiments of the present disclosure. Methods of operating a process management system described with reference to FIGS. 3 through 5 may be performed using the control device 20 controlling the processing devices 30-1 to 30-n. The methods of operating a process management system according to the embodiments of FIGS. 3 through 5 may be provided using a computer including software stored in a computer readable storage medium, and performed by the control device 20. The control device 20, similar to the process management device 40 as illustrated in FIG. 2, may include a communications unit 41, a calculation unit 42, an input unit 43, an output unit 44, and a storage unit 45.

With reference to FIG. 3, in operations of a process management system according to embodiments of the present disclosure, the control device 20 may acquire statistical data relating to a plurality of process parameters applied to a plurality of manufactured wafers (S100). Here, the plurality of manufactured wafers may be wafers manufactured through a plurality of semiconductor processes, for example, a photo process, a deposition process, a washing process, an etching process, a polishing process and the like, and each wafer may include a plurality of semiconductor devices.

The plurality of process parameters, references for acquiring the statistical data in operation S100, may correspond to process conditions applied to the plurality of manufactured wafers in individual processes. For example, a baking temperature, a PR coating speed, and the like, may be process parameters in the photo process; a gas flow amount, a gas pressure, a chuck temperature, and the like, may be process parameters in the deposition process; and RF power, power supplied to a chuck, and the like, may be process parameters in the etching process.

The statistical data relating to the process parameters may be obtained by collecting statistics on the process parameters applied to the plurality of manufactured wafers, respectively. For example, with respect to the plurality of wafers manufactured using the plurality of processes, the gas flow amount, the chuck temperature, and the like, applied to the wafers in the deposition process, may be expressed as normal distribution functions having average values and standard deviations. Similarly, other process parameters such as the baking temperature and the PR coating speed for controlling the photo process may be expressed as numerical data having predetermined distributions. Here, the statistical data relating to respective process parameters may also be expressed as statistical functions other than normal distribution functions.

The control device 20 managing the processing devices 30-1 to 30-n may select at least some of process conditions from among the plurality of process conditions applied to the wafers introduced into the processing devices 30-1 to 30-n as process parameters, and may acquire statistical data relating to the selected process parameters, respectively. In a case in which m wafers are introduced to the processing devices 30-1 to 30-n, the control device 20 may collect values of process parameters such as the baking temperature, the PR coating speed, the gas flow amount, the chuck temperature, the PF power, the chuck power, and the like, and divide the collected values into corresponding process parameters, thereby acquiring the statistical data relating to the corresponding process parameters, respectively.

The control device 20 may select a reference wafer from among the plurality of manufactured wafers (S200). As described above, the reference wafer may be a wafer having a higher production yield rate than a reference yield rate, among the plurality of wafers manufactured using the processing devices 30-1 to 30-n. Here, one or more wafers may be selected as the reference wafers.

When the reference wafer is selected, the control device 20 may compare process parameters applied to the selected reference wafer with the statistical data relating to the corresponding process parameters acquired in operation 100 (S300). In addition, the control device 20 may set respective reference conditions with respect to the process parameters based on the comparison results of operation 300 (S400).

To set the reference conditions, the control device 20 may compare the process parameters applied to the reference wafer with the statistical data relating to the corresponding process parameters, and may assign predetermined values to the process parameters applied to the reference wafer based on the comparison results. For example, in a case in which a specific process parameter is expressed as statistical data in the form of a normal distribution, the control device 20 may assign a predetermined value to the process parameter applied to the reference wafer, according to an average value and a standard deviation of the statistical data relating to the corresponding process parameter.

The reference conditions set in operation S400 may be a group of predetermined values assigned to the process parameters applied to the reference wafer. The control device 20 may control process parameters for wafers to be processed in subsequent processes, according to the reference conditions set in operation S400. The control device 20 may compare the reference conditions set in operation S400 with process parameters of a wafer undergoing processing, thereby predicting a production yield rate of the processing wafer and controlling the process parameters so as to inhibit a reduction in the production yield rate. As further shown in FIG. 3, the process shown may continue during production to keep the processes as close to the references as possible.

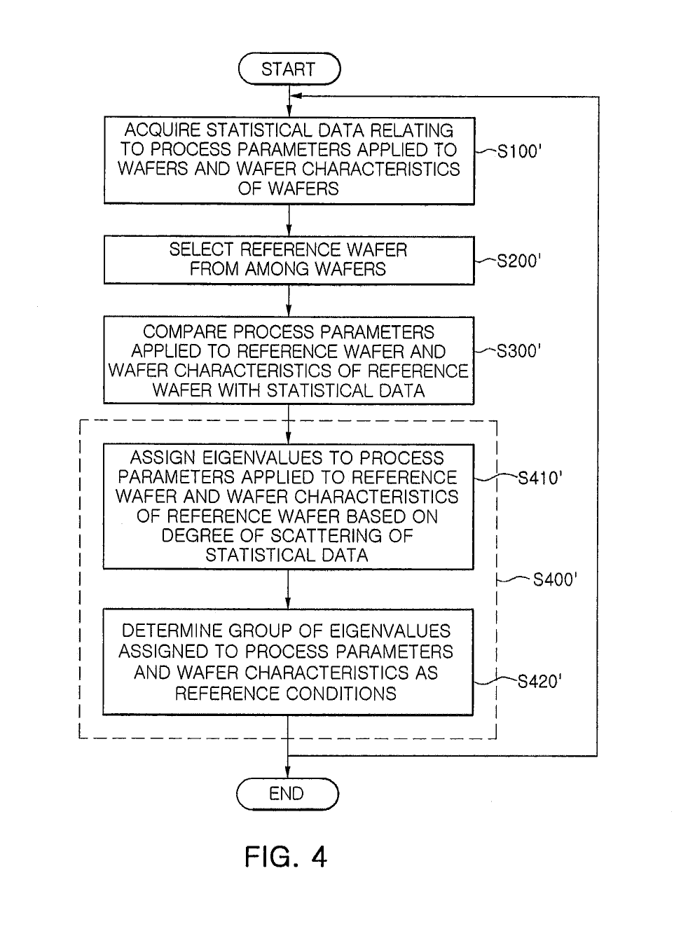

Hereinafter, the operations of a process management system according to exemplary embodiments of the present disclosure will be described with reference to FIG. 4.

With reference to FIG. 4, in the operations of the process management system according to this exemplary embodiment of the present disclosure, the control device 20 may acquire statistical data relating to a plurality of process parameters applied to wafers manufactured by the processing devices 30-1 to 30-n and wafer characteristic values of the wafers (S100′). Unlike the embodiment of FIG. 3, the control device 20 in the embodiment of FIG. 4 may acquire the statistical data relating to the wafer characteristic values measured by at least some of the processing devices 30-1 to 30-n, together with the statistical data relating to the process parameters for controlling semiconductor processes applied to the wafers by the processing devices 30-1 to 30-n. The wafer characteristic values may include an optical reflection spectrum detected by a sensor of a deposition processing device, leveling data measured by a photo processing device, and the like. Unlike the process parameters, the wafer characteristic values may be obtained by measuring the characteristics of the wafers after the semiconductor processes have been completely applied to the wafers by the processing devices 30-1 to 30-n.

In FIG. 4, a reference wafer selecting operation and a comparing operation (S200′ and S300′) may be similar to those illustrated in FIG. 3. In other words, the control device 20 may select a reference wafer from among the plurality of wafers manufactured by the processing devices 30-1 to 30-n (S200′), and may compare process parameters applied to the selected reference wafer and wafer characteristic values of the selected reference wafer with statistical data relating to the corresponding process parameters and wafer characteristic values (S300′).

With reference to FIG. 4, a reference condition setting operation (S400′) may include a plurality of sub-operations S410′ and S420′. The control device 20 may assign eigenvalues to the process parameters applied to the reference wafer selected in operation S200′ and the wafer characteristic values of the reference wafer based on the degrees of scattering of respective statistical data (S410′). Meanwhile, the control device (20) may determine a group of eigenvalues assigned to the process parameters and the wafer characteristic values in operation S410′ as reference conditions (S420′).

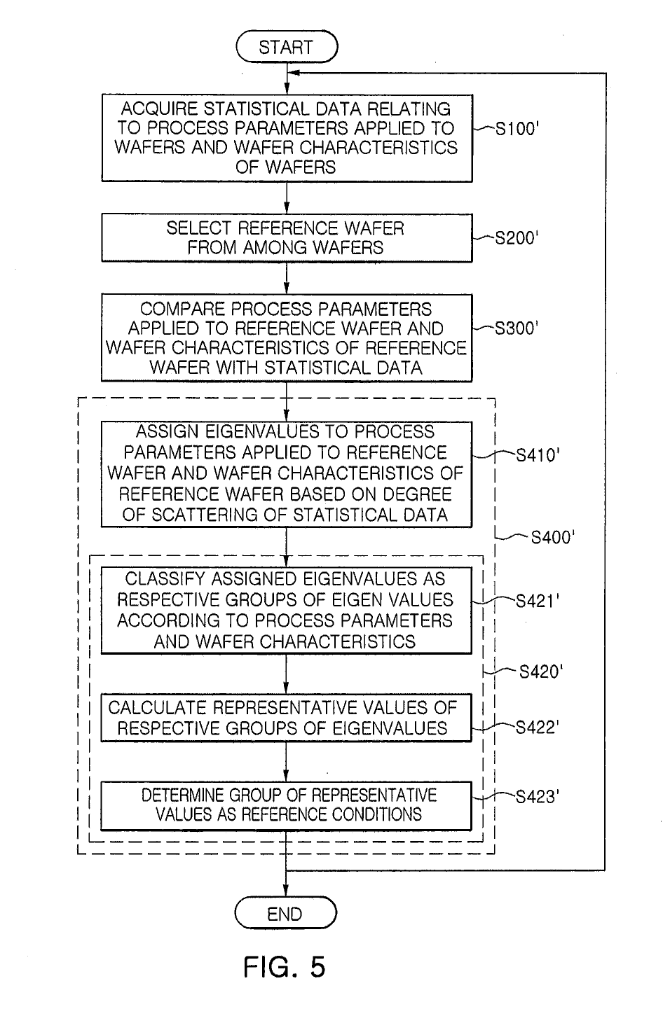

Hereinafter, the operations of a process management system according to exemplary embodiments of the present disclosure will be described with reference to FIG. 5. Operations S100′ to S300′ among the operations illustrated in FIG. 5 are the same as those illustrated in FIG. 4. In other words, the control device 20 may acquire statistical data relating to process parameters applied to wafers manufactured by the plurality of processing devices 30-1 to 30-n, and statistical data relating to wafer characteristic values of the wafers (S100′). The control device 20 may select a reference wafer from among the plurality of wafers manufactured by the processing devices 30-1 to 30-n (S200′), and may compare process parameters applied to the selected reference wafer and wafer characteristic values of the selected reference wafer with statistical data relating to the corresponding process parameters and wafer characteristic values (S300′).

With reference to FIG. 5, similar to the previous embodiment, a reference condition setting operation S400′ may include a plurality of sub-operations S410′ and S420′, and operation S420′ may also include a plurality of sub-operations S421′ to S423′. Operation S410′ may be similar to or the same as that illustrated in FIG. 4. In other words, the control device 20 may assign eigenvalues to the process parameters applied to the reference wafer selected in operation S200′ and the wafer characteristic values of the reference wafer based on the degrees of scattering of respective statistical data (S410′). Meanwhile, the control device 20 may determine a group of eigenvalues assigned in operation S410′ as reference conditions (S420′). In this embodiment of the present disclosure, the plurality of reference wafers may be selected. Since an eigenvalue is assigned to a process parameter with respect to each reference wafer, a plurality of eigenvalues may be assigned to the corresponding process parameter.

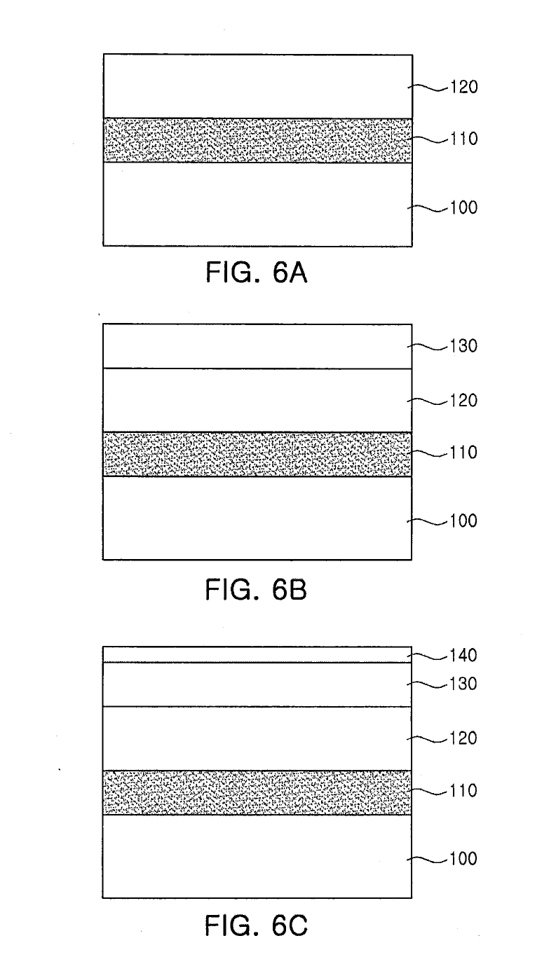

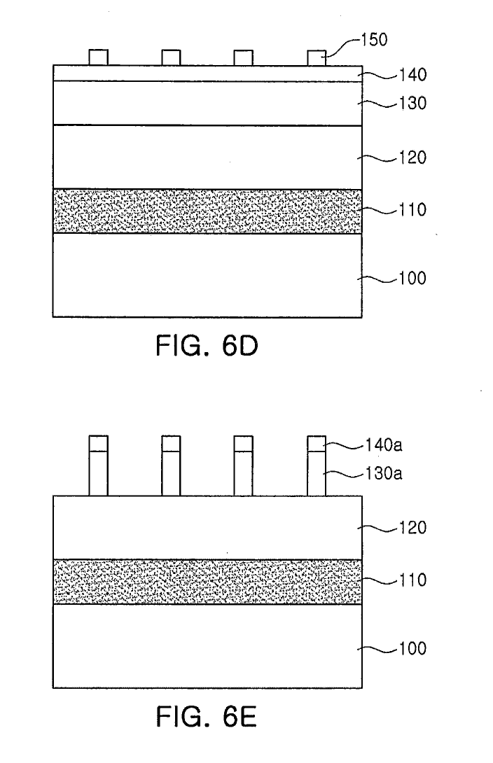

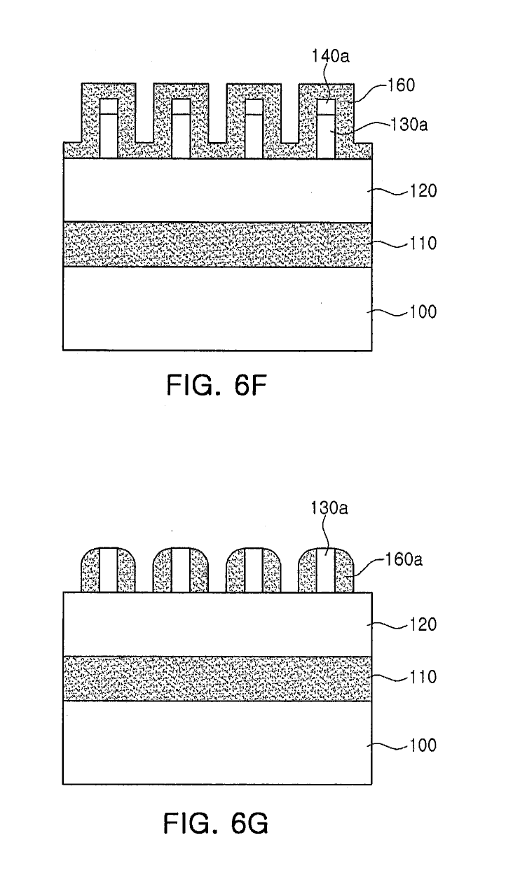

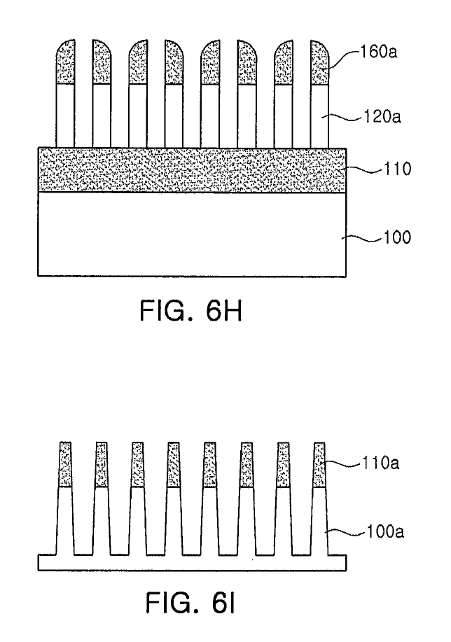

The control device 20 may classify the eigenvalues assigned to the process parameters and the wafer characteristic values as respective groups of eigenvalues (S421′). Each group of eigenvalues classified in operation S421′ may include eigenvalues assigned to a specific process parameter and a specific wafer characteristic value with respect to each reference wafer. The control device 20 may calculate representative values of respective groups of eigenvalues (S422′), and may generate the representative values as a group and determine the group of representative values as the reference conditions (S423′). Details of operations S410′ and S420′ of FIG. 5 will be provided below with reference to FIGS. 6 through 8.

FIGS. 6A through 6I illustrate processes of forming fine patterns in manufacturing a DRAM device.

With respect to FIG. 6A, according to exemplary embodiments of the present disclosure, a first insulating layer 110 and a first mask layer 120 may be formed on a silicon (Si) wafer substrate 100. The first insulating layer 110 may be an oxide layer, and the first mask layer 120 may be formed of a material selected from a silicon oxide (SiO₂), a silicon nitride (Si₃N₄), and a material containing silicon such as polysilicon. The first insulating layer 110 and the first mask layer 120 may be formed by a chemical vapor deposition (CVD) process. Accordingly, a first process for forming the first insulating layer 110 and the first mask layer 120 may be a deposition process, and the control device 20 may select a gas flow amount, a chuck temperature, and the like, as process parameters, and may select optical reflection spectrum data obtained by the sensor after the first insulating layer 110 and the first mask layer 120 have been formed, as wafer characteristic values.

With respect to FIG. 6B, a second mask layer 130 may be formed on the first mask layer 120. A second mask layer 130 may be formed of a film including a hydrocarbon compound having a high carbon content or derivatives thereof, such as an amorphous carbon layer (ACL) or a spin on hardmask (SOH), a metal or an organic material. Unlike the first insulating layer 110 and the first mask layer 120, the second mask layer 130 may be formed by a spin coating process. Accordingly, the control device 20 may select a coating speed as a process parameter in a second process for forming the second mask layer 130.

With reference to FIG. 6C, a first antireflection layer 140 may be formed on the second mask layer 130. The first antireflection layer 140 may inhibit reflection in a follow-up photo lithography process, and may include silicon oxynitride (SiON). A third process for forming the first antireflection layer 140 may be a deposition process which is similar to the first process. Accordingly, the control device 20 may select a gas flow amount, a chuck temperature, or the like, as process parameters, and may select optical reflection spectrum data, as wafer characteristic values obtained by the sensor after the first antireflection layer 140 has been formed.

With reference to FIG. 6D, a first PR pattern 150 for a photolithography process may be formed on the first antireflection layer 140. Accordingly, a fourth process illustrated in FIG. 6D may be a photo process. The control device 20 may select a PR coating speed for forming the first PR pattern 150 as a process parameter, and may select leveling data as wafer characteristic values obtained after the first PR pattern 150 has been formed.

In a case in which patterning is completed after the first PR pattern 150 is formed, an antireflection pattern 140a and a second pattern 130a may be formed by etching the first antireflection layer 140 and the second mask layer 130. With reference to FIG. 6E, the antireflection pattern 140a and the second pattern 130a may be formed on the first mask layer 120, the first mask layer 120, the first insulating layer 110 and the wafer substrate 100 may not be etched. In other words, a fifth process illustrated in FIG. 6E may be an etching process, and the control device 20 may select OES data generated in the etching process as process parameters.

With reference to FIG. 6F, a spacer mask layer 160 may be formed on the antireflection pattern 140a and the second pattern 130a. The spacer mask layer 160 may be formed of a material, for example, an oxide film, having an etching selectivity different from that of the second mask layer 130. The spacer mask layer 160 may be formed through a deposition process such as atomic layer deposition (ALD). Accordingly, a sixth process illustrated in FIG. 6F may be a deposition process, and the control device 20 may select a gas flow amount, a chuck temperature, and the like, as process parameters, and may select light reflection spectrum data obtained by the sensor as wafer characteristic values after the spacer mask layer 160 has been formed, like the first and third processes.

With reference to FIG. 6G, the spacer mask layer 160 may be etched until the top of the first mask layer 120 and the top of the second pattern 130a are exposed, and spacers 160a covering sides of the second pattern 130a may be formed. The spacers 160a may be used as an etching mask for enhancing a density of a fine pattern, and while the spacer mask layer 160 is etched, the antireflection pattern 140a may also be etched and removed. In other words, a seventh process illustrated in FIG. 6G may be an etching process, and the control device 20 may select OES data generated as process parameters in the seventh process.

With respect to FIG. 6H, portions of the second pattern 130a and the first mask layer 120 may be removed by performing an etching process as an eighth process. The second pattern 130a may first be removed and the first mask layer 120 may be exposed through a space between neighboring spacers 160a and removed to thereby form a first pattern 120a as illustrated in FIG. 6H. Similarly to the fifth and seventh processes, the control device 20 may select OES data generated in the etching process as process parameters of an eighth process.

With reference to FIG. 6I, an etching process may be performed as a ninth process. As illustrated in FIG. 6I, the first insulating layer 110 may be etched by using the spacers 160a and the first pattern 120a as an etching mask. The spacers 160a may also be etched and removed while the first insulating layer 110 is etched. Then, portions of the wafer substrate 100 may be etched to form a wafer substrate pattern 100a. Accordingly, the ninth process for forming the wafer substrate pattern 100a may be an etching process, especially, a dry etching process in embodiments of the present disclosure. The control device 20 may select OES data generated in the etching process as process parameters of the ninth process.

As described in the processes of forming the fine pattern in the DRAM device according to exemplary embodiments of FIGS. 6A through 6I, the control device 20 may select and acquire process parameters and wafer characteristic values with respect to all wafers during each process, and may generate statistical data relating to the acquired process parameters and wafer characteristic values.

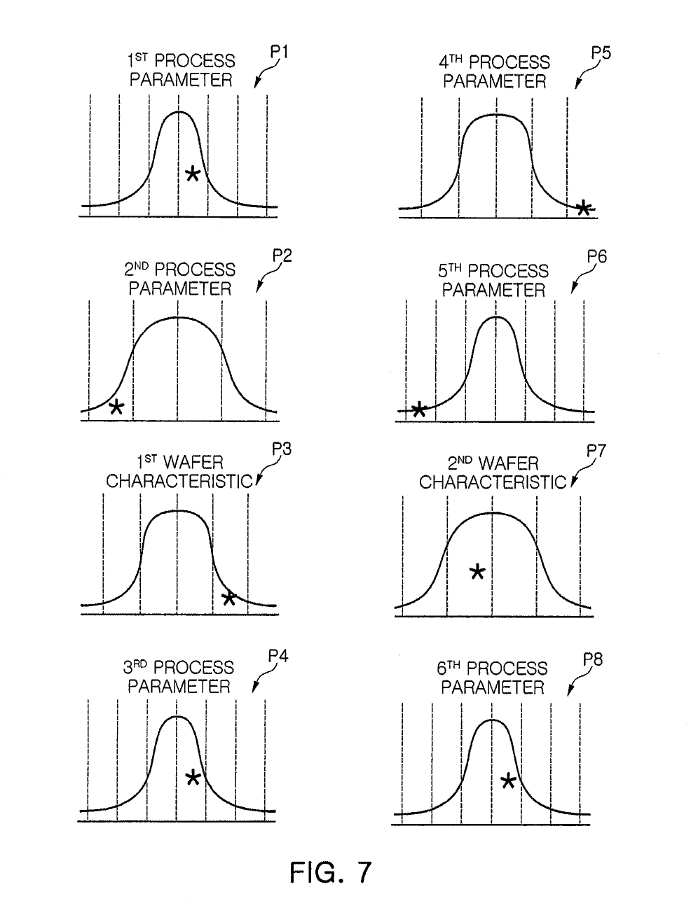

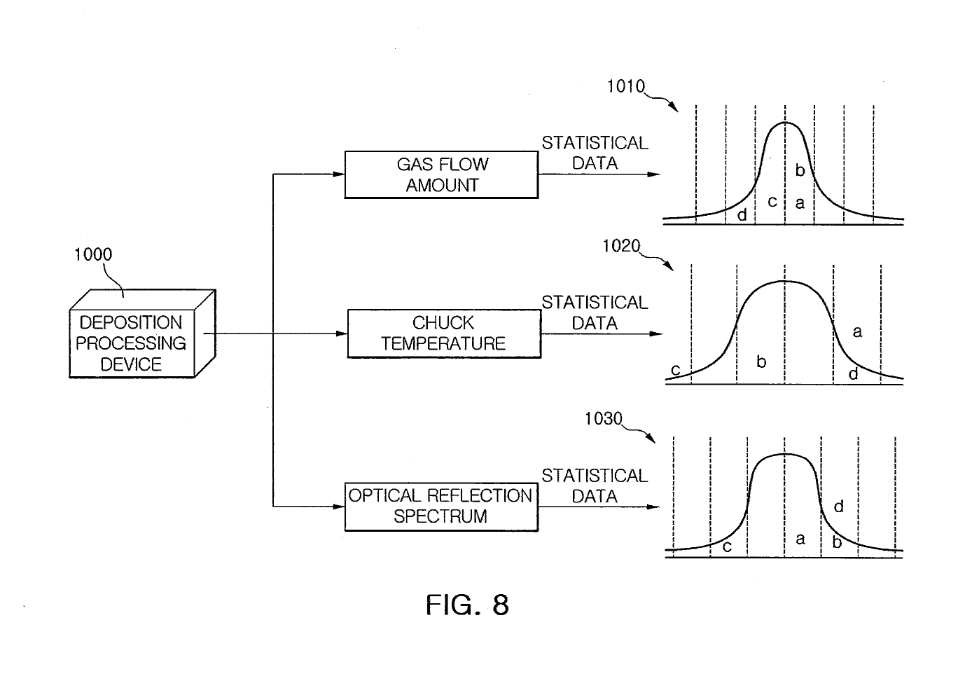

Hereinafter, a method of setting reference conditions in a process management system according to exemplary embodiments of the present disclosure will be described with reference to FIGS. 7 and 8. For convenience of explanation, it is assumed that the processes of forming the fine pattern in the DRAM device as illustrated in FIGS. 6A through 6I are performed by the processing devices 30-1 to 30-n illustrated in FIG. 1, and are managed by the control device 20 illustrated in FIG. 1.

With reference to FIG. 7, statistical data P1 to P8 relating to 6 process parameters and 2 wafer characteristic values are illustrated, each of which is expressed by a normal distribution curve. The normal distribution curve has bilateral symmetrical distribution on the basis of an average value, and a width of the normal distribution curve may be determined according to the degree of scattering of data expressed by the normal distribution curve. For example, a second statistical data P2 relating to a second process parameter may have a greater degree of scattering than that of a first statistical data P1 of a first process parameter.

In this embodiment of the present disclosure, first to sixth process parameters and first and second wafer characteristic values may be obtained in the processes of forming the fine pattern in the DRAM device as illustrated in FIGS. 6A through 6I. Hereinafter, for convenience of explanation, the following is assumed: the first and second process parameters correspond to the gas flow amount and the chuck temperature acquired in the first process of FIG. 6A, respectively; the first wafer characteristic value corresponds to the optical reflection spectrum data acquired in the first process; the third process parameter corresponds to the spin coating speed acquired in the second process of FIG. 6B; the fourth and fifth process parameters correspond to the gas flow amount and the chuck temperature acquired in the third process of FIG. 6C, respectively; the second wafer characteristic value corresponds to the optical reflection spectrum data acquired in the third process; and the sixth process parameter corresponds to the PR coating speed acquired in the fourth process of FIG. 6D.

The statistical data P1 to P8 acquired by the control device 20 may be obtained from the plurality of wafers manufactured by the processing devices 30-1 to 30-n. The control device 20 may acquire the first statistical data P1 relating to the first process parameter as illustrated in FIG. 7, by collecting data relating to gas flow amounts applied to the wafer substrates 100 introduced into the first processing device 30-1 performing the deposition process on the wafer substrates 100, and performing a statistical analysis. Similarly, the control device 20 may acquire the second statistical data P2 relating to the second process parameter by collecting data relating to chuck temperatures applied to the wafer substrates 100 introduced into the first processing device 30-1, and performing a statistical analysis. Also, the control device 20 may acquire a third statistical data P3 relating to the first wafer characteristic value by performing an optical reflection spectrum analysis on the wafer substrates 100 which have been processed by the first processing device 30-1 using the sensor.

Each of the statistical data P1 to P3 acquired by the control device 20 may be divided into a plurality of sections based on degrees of deviation. With respect to FIG. 7, the first statistical data P1 relating to the first process parameter, the gas flow amount, may be divided into a total of 8 sections according to standard deviations based on an average value. Also, each of the second statistical data P2 and the third statistical data P3 having a standard deviation greater than that of the first statistical data P1 may be divided into a total of 6 sections.

The control device 20 may select a reference wafer having a yield rate greater than a reference yield rate from among the plurality of wafers manufactured by the plurality of processing devices 30-1 to 30-n, compare process parameter values applied to the reference wafer and wafer characteristic values of the reference wafer with the statistical data P1 to P8, and assign eigenvalues to the corresponding process parameter values and wafer characteristic values. The eigenvalues assigned to the process parameter values and the wafer characteristic values of the reference wafer may be determined according to sections of the statistical data P1 to P8 relating to the corresponding process parameters and wafer characteristic values to which the process parameter values applied to the reference wafer and the wafer characteristic values of the reference wafer belong. The eigenvalues assigned to the process parameter values and the wafer characteristic values of the reference wafer may be determined according to Equation 1 below. In Equation 1, m refers to an average value of each of the statistical data P1 to P8, a refers to a standard deviation value of each of the statistical data P1 to P8.

0≦|process parameter applied to reference wafer|<m+σ,eigenvalue=1

m+σ≦|process parameter applied to reference wafer|<m+2σ,eigenvalue=2

m+2σ≦|process parameter applied to reference wafer|<m+3σ,eigenvalue=3

|process parameter applied to reference wafer|≧m+3σ,eigenvalue=4 [Equation 1]

With reference to FIG. 7, values indicated with asterisks (*) are the first to sixth process parameter values applied to the reference wafer and the first and second wafer characteristic values of the reference wafer in this embodiment of the present disclosure. Accordingly, the eigenvalues assigned to the process parameter values and the wafer characteristic values of the reference wafer in the embodiment of the present disclosure are determined as illustrated in Table 1.

TABLE 1

| Item | Eigenvalue |
|---|---|
| First Process Parameter | 1 |
| Second Process Parameter | 2 |
| First Wafer Characteristic | 2 |
| Third Process Parameter | 1 |
| Fourth Process Parameter | 3 |
| Fifth Process Parameter | 3 |
| Second Wafer Characteristic | 1 |
| Sixth Process Parameter | 1 |

The control device 20 may set a group of eigenvalues [1, 2, 2, 1, 3, 3, 1, 1] obtained through Equation 1 as reference conditions. Since the reference conditions are the group of eigenvalues calculated from the process parameters applied to the reference wafer having a relatively high yield rate among the manufactured wafers and the wafer characteristic values of the reference wafer, the reference conditions are regarded as conditions allowing wafers introduced into the processing devices 30-1 to 30-n to achieve high yield rates.

The eigenvalues set as the reference conditions may define a limit on a range of process parameter values appropriate for a wafer undergoing processing and a limit on a range of wafer characteristic values of the corresponding wafer in order to prevent a reduction in the yield rate of the corresponding wafer. For example, with reference to the second process parameter of FIG. 7, as an eigenvalue with respect to the chuck temperature in the deposition process is set as 2, in a case in which the chuck temperature being applied to the wafer during the deposition process is in a range of m−2σ to m+2σ, it is determined that the chuck temperature during the deposition process is under control. On the contrary, in a case in which the chuck temperature applied to the wafer during the deposition process is in a section that is less than m−2σ or greater than m+2σ, it is determined that there is a problem in controlling the chuck temperature during the deposition process.

Meanwhile, in a case in which a wafer having a yield rate greater than that of the reference wafer used for providing the reference conditions is manufactured, the existing reference conditions as illustrated in Table 1 may be updated by eigenvalues calculated from the wafer having a higher yield rate. For example, if the reference conditions [1, 2, 2, 1, 3, 3, 1, 1] in Table 1 are acquired from a reference wafer having a yield rate of 93%, in a case in which a wafer having a yield rate of 95% is manufactured, the reference conditions of Table 1 may be updated with a group of eigenvalues calculated from process parameters and wafer characteristic values of the wafer having the yield rate of 95%. Accordingly, while inspecting yield rates of all wafers, the control device 20 may track process parameters applied to each wafer and wafer characteristic values of each wafer in real time and store these values, so that it may determine whether to update reference conditions according to the yield rates of the wafers manufactured by the processing devices 30-1 to 30-n.

FIG. 8 is a view illustrating methods of setting reference conditions in process management according to exemplary embodiments of the present disclosure.

FIG. 8 illustrates eigenvalues assigned to gas flow amounts and chuck temperatures which are process parameters applicable to four reference wafers a, b, c and d introduced into a deposition processing device 1000, and assigned to optical reflection spectrum data which are wafer characteristics of the wafers having been processed by the deposition processing device 1000. The gas flow amounts, the chuck temperatures, and the optical reflection spectrum may be expressed as statistical data in the form of normal distribution curves having different average values and standard deviations, and the four reference wafers a, b, c, and d may have different eigenvalues for each of the gas flow amounts, the chuck temperatures, and the optical reflection spectrum. The eigenvalues assigned to the corresponding process parameters and wafer characteristics of the four reference wafers a, b, c, and d may be determined according to Equation 1.

With reference to FIG. 8, as compared with statistical data 1010 relating to deposition temperatures, a first reference wafer a may have an eigenvalue 1, and second to fourth reference wafers b, c, and d may have eigenvalues 1, 1, and 2, respectively. Similarly, in a case in which predetermined values are assigned to the corresponding process parameters and wafer characteristics of the first to fourth reference wafers a, b, c, and d, the results are given in Table 2.

TABLE 2

| | Gas Flow | Chuck | Optical Reflection |
|---|---|---|---|
| Item | Amount | Temperature | Spectrum |
| First Reference Wafer | 1 | 2 | 1 |
| Second Reference Wafer | 1 | 1 | 2 |
| Third Reference Wafer | 1 | 3 | 2 |
| Fourth Reference Wafer | 2 | 2 | 2 |
| Representative Value | 1 | 2 | 2 |

That is, in the exemplary embodiment of the present disclosure, the eigenvalues assigned to the gas flow amounts and the chuck temperatures which are the process parameters applied to the wafers introduced into the deposition processing device 1000, and the eigenvalues assigned to the optical reflection spectrum data which are wafer characteristics of the wafers having been processed by the deposition processing device 1000 may be given in a 4×3 matrix form, because the plurality of reference wafers a, b, c, and d are provided. The control device 20 may classify the eigenvalues given in Table 2 as respective groups of eigenvalues according to the process parameters and the wafer characteristics. That is, in Table 2, a first group of eigenvalues relating to the gas flow amounts of the deposition processing device 1000 is given as [1, 1, 1, 2]; a second group of eigenvalues relating to the chuck temperatures of the deposition processing device 1000 is given as [2, 1, 3, 2]; and a third group of eigenvalues relating to the optical reflection spectrum measured by a sensor included in the deposition processing device 1000 is given as [1, 2, 2, 2].

The control device 20 may calculate a representative value for each of the classified groups of eigenvalues. The representative value calculated by the control device 20 with respect to each group of eigenvalues may be an average value or a median value of the eigenvalues included in each group of eigenvalues. In this embodiment of the present disclosure, the control device 20 may calculate an arithmetic average of the eigenvalues included in each group of eigenvalues and the calculated result may be rounded off to the nearest whole number to thereby calculate a representative value of the corresponding group. Accordingly, the representative values of the first to third groups of eigenvalues are given as 1, 2 and 2, respectively.

As described above, in a case in which the plurality of reference wafers are provided, the control device 20 may assign the eigenvalues to the process parameters and the wafer characteristics of respective reference wafers, and may classify the assigned eigenvalues according to the process parameters and the wafer characteristics to generate respective groups of predetermined values. The control device 20 may calculate the representative values of the corresponding groups of eigenvalues, and may set a group of representative values as reference conditions.

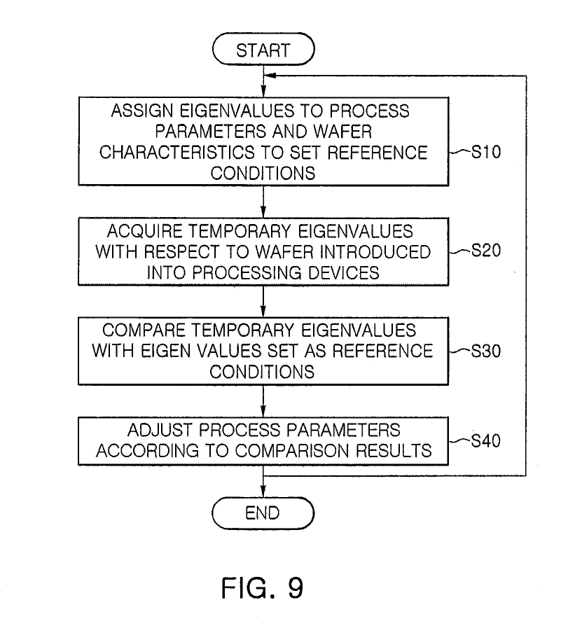

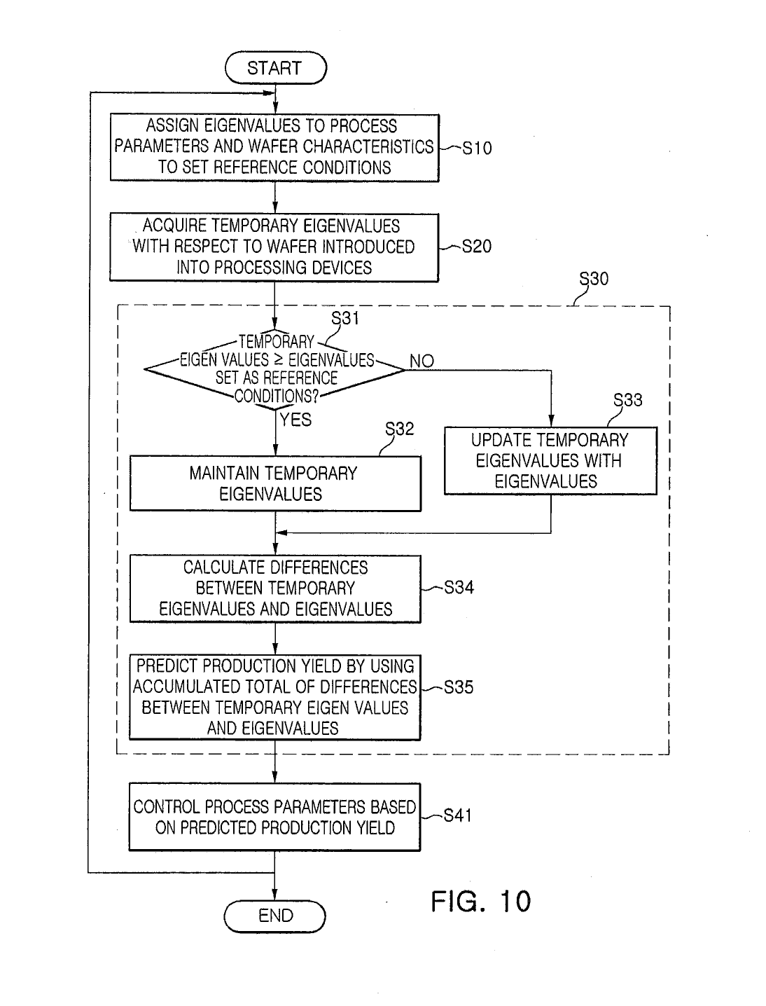

FIGS. 9 and 10 are flowcharts illustrating operations of a process management system according to embodiments of the present disclosure.

With reference to FIG. 9, in the operations of the process management system according to this embodiment of the present disclosure, eigenvalues may be assigned to process parameters and wafer characteristics to set reference conditions (S10). The reference conditions set in operation S10 may be defined by a group of eigenvalues assigned to process parameters applied to a reference wafer having a greater yield rate than a reference yield rate, among a plurality of wafers introduced into the processing devices 30-1 to 30-n, and assigned to wafer characteristic values of the reference wafer.

The control device 20 may acquire temporary eigenvalues with respect to a wafer introduced into the processing devices 30-1 to 30-n to which the set reference conditions are applied, by using process parameter values applied to the corresponding wafer and wafer characteristic values of the corresponding wafer (S20). In operation S20, the control device 20 may acquire the temporary eigenvalues by comparing the process parameter values applied to the wafer introduced into the processing devices 30-1 to 30-n and undergoing processing with statistical data relating to the corresponding process parameters. Also, the control device 20 may acquire the temporary eigenvalues by comparing the wafer characteristic values of the wafer introduced into the processing devices 30-1 to 30-n and undergoing processing with statistical data relating to the corresponding wafer characteristics.

In other words, the temporary eigenvalues may be produced by using the same method as that of assigning the eigenvalues to the process parameter values applied to the reference wafer and the wafer characteristic values of the reference wafer in order to set the reference conditions in operation S10. The temporary eigenvalues may be acquired with respect to a completed process. For example, in a case in which the wafer is being processed in the third processing device 30-3, temporary eigenvalues may be acquired with respect to process parameters applied to the wafer in the first and second processing devices 30-1 and 30-2 and wafer characteristic values of the corresponding wafer measured by sensors included in the first and second processing devices 30-1 and 30-2.

In a case in which the temporary eigenvalues are acquired, the control device 20 may compare the temporary eigenvalues with the eigenvalues set as the reference conditions (S30), and may adjust process parameters to be applied to the processing wafer, according to the comparison results (S40). For example, as described with reference to FIG. 7, it is assumed that the reference conditions defined as the group of eigenvalues assigned to the first to sixth process parameters and the first and second wafer characteristic values are given as [1, 2, 2, 1, 3, 3, 1, 1].

Here, if temporary eigenvalues acquired with respect to the wafer undergoing processing are [1, 3, 1, 1, 2, 2, 1, 2], it is determined that the second and sixth process parameters are out of the reference conditions. Accordingly, the control device 20 may determine that there are problems in controlling the second and sixth process parameters in which the temporary eigenvalues are higher than the eigenvalues set as the reference conditions, and may adjust the corresponding second and sixth process parameters in the first processing device 30-1 controlling the second process parameter and in the fourth processing device 30-4, which is a photo processing device, controlling the sixth process parameter.

Hereinafter, operation (S30) of comparing the temporary eigenvalues with the eigenvalues among the operations illustrated in the flowchart of FIG. 9 will be described in detail with reference to a flowchart of FIG. 10.

With reference to FIG. 8, the control device 20 may set the group of eigenvalues assigned to the process parameters applied to the reference wafer having a relatively high yield rate among the plurality of wafers introduced into the plurality of processing devices 30-1 to 30-n and the wafer characteristics of the reference wafer as the reference conditions (S10). Moreover, the control device 20 may compare the process parameter values applied to the wafer undergoing processing and the wafer characteristic values of the corresponding wafer with the corresponding statistical data to thereby acquire the temporary eigenvalues (S20).

The control device 20 may compare the temporary eigenvalues acquired in operation S20 with the eigenvalues set as the reference conditions (S31). In operation S31, the control device 20 may compare the temporary eigenvalues with the eigenvalues according to the process parameters. That is, a temporary eigenvalue relating to a deposition temperature may be compared with an eigenvalue relating to the deposition temperature; and a temporary eigenvalue relating to a baking time may be compared with an eigenvalue relating to the baking time.

As a result of comparison in operation S31, if it is determined that the temporary eigenvalues are equal to or greater than the eigenvalues set as the reference conditions, the control device 20 may maintain the corresponding temporary eigenvalues with respect to a wafer undergoing processing (S32). On the contrary, if it is determined (S31) that the temporary eigenvalues are less than the eigenvalues set as the reference conditions, the control device 20 may change the temporary eigenvalues to the eigenvalues set as the reference conditions (S33). When the temporary eigenvalues are less than the eigenvalues, the corresponding process parameters and wafer characteristics are well controlled, and the following operation S34 may proceed with preventing the temporary eigenvalues less than the eigenvalues from influencing predicted yield rates of wafers.

After the temporary eigenvalues are compared with the eigenvalues set as the reference conditions, the control device 20 may calculate differences between the temporary eigenvalues and the eigenvalues according to the process parameters and the wafer characteristics (S34), and may predict a yield rate of the wafer undergoing processing by using an accumulated total of the differences calculated in operation S34 (S35). In the case in which the temporary eigenvalues are less than the eigenvalues, it is determined that the processing devices 30-1 to 30-n applying the corresponding process parameters to the wafer are smoothly operated for process control. On the contrary, in the case in which the temporary eigenvalues are greater than the eigenvalues, it is determined that errors occur in the process control of the processing devices 30-1 to 30-n applying the corresponding process parameters to the wafer.

Meanwhile, in the operation of predicting the yield rate of the wafer by accumulating the differences between the temporary eigenvalues and the eigenvalues set as the reference conditions, in the case in which temporary eigenvalues with respect to particular process parameters or wafer characteristic values are lower than corresponding eigenvalues, the control device 20 may change the temporary eigenvalue to the eigenvalue as described in operation S33. When errors occur in the process control of any processing devices 30-1 to 30-n controlling process parameters and wafer characteristic values in which the corresponding temporary eigenvalues are greater than the corresponding eigenvalues set as the reference conditions, only the influence thereof may be reflected in the wafer undergoing processing. Thus, only the influence on the yield rate caused by any processing devices 30-1 to 30-n having the errors in process control may be selectively determined.

The control device 20 may control process parameters based on the yield rate predicted with respect to the wafer undergoing processing (S41). Since the yield rate is lowered as the accumulated total of differences between the temporary eigenvalues and the eigenvalues set as the reference conditions increases, the control device 20 may adjust the process parameters across all of the processing devices 30-1 to 30-n according to the degree of accumulated differences. Here, if the accumulated total of differences calculated in operation S35 is greater than a predetermined reference value, the corresponding wafer is determined to be a defective product and is discharged from the processing devices 30-1 to 30-n.

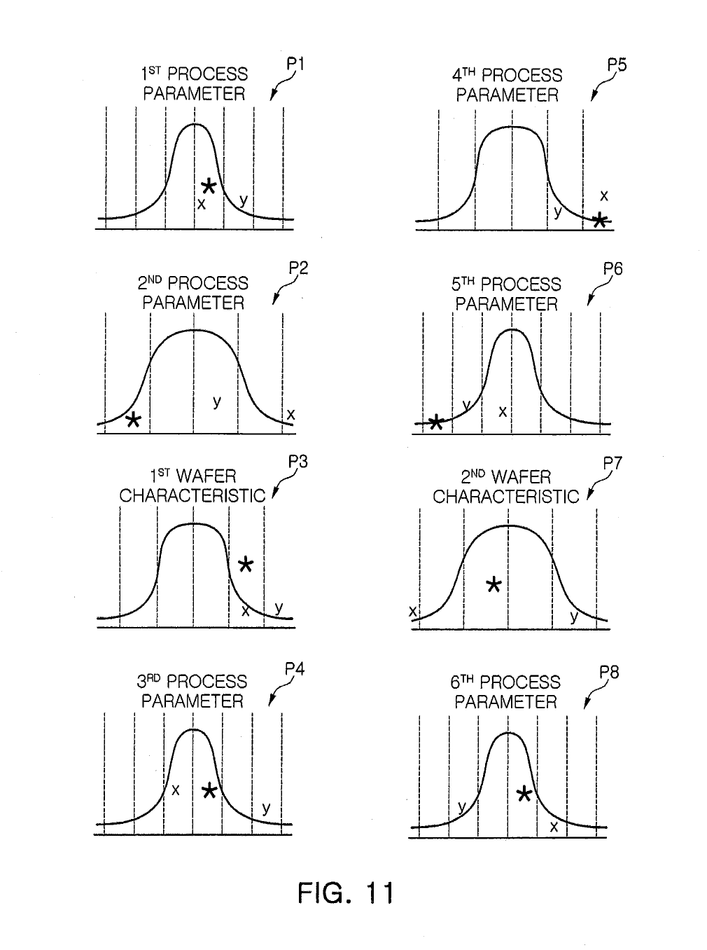

Hereinafter, operation S30 of FIG. 10 will be described in more detail with reference to FIG. 11.

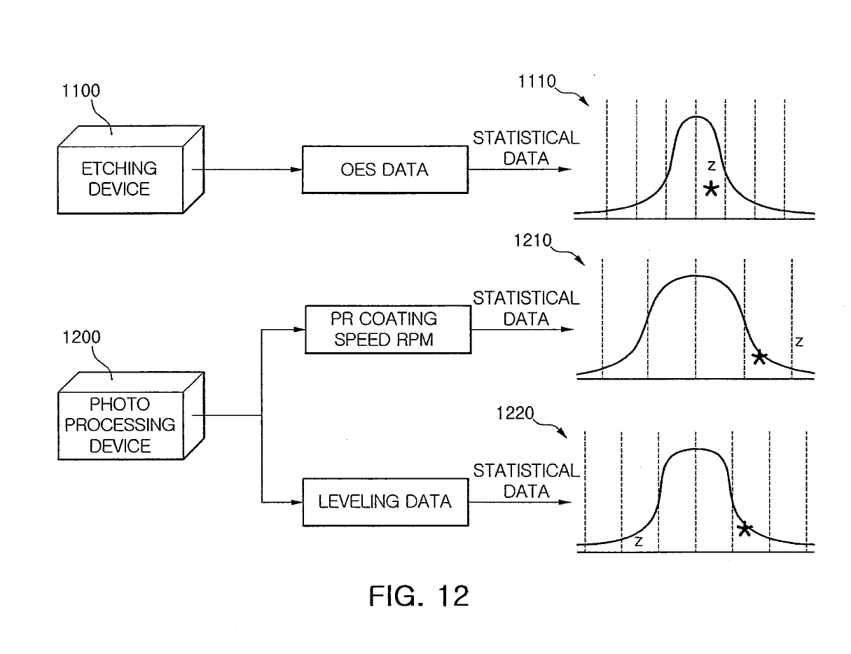

FIGS. 11 and 12 are views illustrating the operations of a process management system according to exemplary embodiments of the present disclosure.

With respect to 6 process parameters and 2 wafer characteristics, FIG. 11 illustrates temporary eigenvalues (x, y) acquired from a wafer undergoing processing and eigenvalues (*) acquired from a reference wafer having a yield rate higher than a reference yield rate and set as reference conditions. The reference conditions are defined by a group of eigenvalues which are obtained by comparing process parameter values applied to the reference wafer and wafer characteristic values of the reference wafer with statistical data P1 to P8 and assigning the eigenvalues to the corresponding process parameter values and wafer characteristic values. The reference conditions according to the embodiment of FIG. 11 are given [1, 2, 2, 1, 3, 3, 1, 1]. A temporary eigenvalue x may be a process parameter value applied to a first wafer and a wafer characteristic value of the first wafer, and a temporary eigenvalue y may be a process parameter value applied to a second wafer and a wafer characteristic value of the second wafer.

In addition, in the embodiment of FIG. 11, a group of temporary eigenvalues x acquired from the first wafer undergoing processing is [1, 3, 2, 1, 3, 1, 3, 2], and a group of temporary eigenvalues y acquired from the second wafer is [2, 1, 3, 3, 2, 2, 2, 2]. As illustrated in operations S31 to S33 of FIG. 10, the control device 20 may compare the eigenvalues set as the reference conditions with the temporary eigenvalues x and y and update the temporary eigenvalues x and y with the eigenvalues set as the reference conditions or maintain the temporary eigenvalues according to the comparison results. In a case in which the method including operations S31 to S33 is applied to the embodiment of FIG. 11, the following results may be obtained as shown in Tables 3 and 4 below. In Tables 3 and 4, item “difference” refers to differences between updated temporary eigenvalues (x′−*) and (y′−*) and corresponding eigenvalues (*) set as the reference conditions.

TABLE 3

| | | Temporary | Updated | |
|---|---|---|---|---|
| | Eigenvalue | Eigenvalue | Temporary | Difference |
| Item | (*) | (x) | Eigenvalue (x′) | (x′ − *) |
| First Process | 1 | 1 | 1 | 0 |
| Parameter | | | | |
| Second Process | 2 | 3 | 3 | 1 |
| Parameter | | | | |
| First Wafer | 2 | 2 | 2 | 0 |
| Characteristics | | | | |
| Third Process | 1 | 1 | 1 | 0 |
| Parameter | | | | |
| Fourth Process | 3 | 3 | 3 | 0 |
| Parameter | | | | |
| Fifth Process | 3 | 1 | 3 | 0 |
| Parameter | | | | |
| Second Wafer | 1 | 3 | 3 | 2 |
| Characteristics | | | | |
| Sixth Process | 1 | 2 | 2 | 1 |
| Parameter | | | | |

TABLE 4

| | | Temporary | Updated | |
|---|---|---|---|---|
| | Eigenvalue | Eigenvalue | Temporary | Difference |
| Item | (*) | (y) | Eigenvalue (y′) | (y′ − *) |
| First Process | 1 | 2 | 2 | 1 |
| Parameter | | | | |
| Second Process | 2 | 1 | 2 | 0 |
| Parameter | | | | |
| First Wafer | 2 | 3 | 3 | 1 |
| Characteristics | | | | |
| Third Process | 1 | 3 | 3 | 2 |
| Parameter | | | | |
| Fourth Process | 3 | 2 | 3 | 0 |
| Parameter | | | | |
| Fifth Process | 3 | 2 | 3 | 0 |
| Parameter | | | | |
| Second Wafer | 1 | 2 | 2 | 1 |
| Characteristics | | | | |
| Sixth Process | 1 | 2 | 2 | 1 |
| Parameter | | | | |

With reference to Table 3, in the second and sixth process parameters and the second wafer characteristics, the temporary eigenvalues x are greater than the eigenvalues *; and in the fifth process parameter, the temporary eigenvalue x is less than the eigenvalue*. Accordingly, the control device 20 may update the temporary eigenvalue x applied to the fifth process parameter with the eigenvalue * applied to the fifth process parameter and may maintain the temporary eigenvalues x applied to the other process parameters. A group of updated temporary eigenvalues x′ is given as [1, 3, 2, 1, 3, 3, 3, 2]. The updated temporary eigenvalues x′ may be acquired by the control device 20 through operations S31 to S33 illustrated in the flowchart of FIG. 10.

The control device 20 may calculate the differences between the updated temporary eigenvalues x′ and the eigenvalues *. The differences between the updated temporary eigenvalues x′ and the eigenvalues * in the embodiment of Table 3 may appear in the second and sixth process parameters, and the second wafer characteristics. Accordingly, the control device 20 may monitor the control of the second and sixth process parameters and adjust the corresponding process parameters, while controlling an overall operation of the processing device including the sensor determining the second wafer characteristics.

With reference to Table 4, in the first, third and sixth process parameters and the first and second wafer characteristics, the temporary eigenvalues y are greater than the eigenvalues *; and in the second, fourth, and fifth process parameters, the temporary eigenvalues y are less than the eigenvalues *. Accordingly, the control device 20 may update the temporary eigenvalues y applied to the second, fourth, and fifth process parameters with the eigenvalues * applied to the second, fourth, and fifth process parameters and may maintain the temporary eigenvalues y applied to the other process parameters. A group of updated temporary eigenvalues y′ is given as [2, 2, 3, 3, 3, 3, 2, 2]. The updated temporary eigenvalues y′ may be acquired by the control device 20 through operations S31 to S33 in the flowchart of FIG. 10.

The control device 20 may calculate the differences between the updated temporary eigenvalues y′ and the eigenvalues *. The differences between the updated temporary eigenvalues y′ and the eigenvalues * in the embodiment of Table 4 may appear in the first, third and sixth process parameters, and the first and second wafer characteristics. Accordingly, the control device 20 may monitor the control of the first, third and sixth process parameters and adjust the corresponding process parameters, while controlling an overall operation of the processing devices including the sensors determining the first and second wafer characteristics.

Meanwhile, in a case in which accumulated difference values between the updated temporary eigenvalues x′ and y′ and the eigenvalues * set as the reference conditions are calculated, the accumulated difference value in the embodiment of Table 3 is 4, and the accumulated difference value in the embodiment of Table 4 is 6. Accordingly, the control device 20 may predict that a yield rate will be further lowered in the embodiment of Table 4 since the accumulated difference value in the embodiment of Table 4 is higher than that in the embodiment of Table 3.

FIG. 12 is a view illustrating a method of adjusting process parameters of a processing device in a process management method according to exemplary embodiments of the present disclosure.

With reference to FIG. 12, OES data may be selected as a process parameter of an etching device 1100, and PR coating speed RPM may be selected as a process parameter of a photo processing device 1200. Also, leveling data may be selected as wafer characteristics of the photo processing device 1200. Statistical data 1110, 1210, and 1220 relating to respective process parameters and wafer characteristics may be expressed as normal distribution curves. In this embodiment of the present disclosure, the etching device 1100 and the photo processing device 1200 may be included in the n number of processing devices 30-1 to 30-n illustrated in FIG. 1, and may be connected to and communicate with the control device 20. The statistical data 1110, 1210, and 1220 relating to the selected process parameters and wafer characteristics may be calculated by the control device 20. As described above, the statistical data 1110, 1210, and 1220 illustrated in FIG. 12 may be derived from the degrees of scattering of the process parameters applied to the plurality of wafers manufactured by the processing devices 30-1 to 30-n and the degrees of scattering of the wafer characteristics of the manufactured wafers. In FIG. 12, all of the statistical data 1110, 1210, and 1220 are expressed as the normal distribution functions; however, they may be expressed as different statistical functions.

The control device 20 may compare the statistical data 1110, 1210, and 1220 with process parameters applied to a reference wafer and wafer characteristic values of the reference wafer, assign eigenvalues to the corresponding process parameters and wafer characteristics, and set a group of eigenvalues as reference conditions. The reference wafer may have a higher yield rate than a reference yield rate among the plurality of wafers manufactured by the processing devices 30-1 to 30-n. The assigning of the eigenvalues to the corresponding process parameters and wafer characteristics may be implemented according to Equation 1.

In FIG. 12, the predetermined values (*) assigned to the OES data, the PR coating speed RPM, and the leveling data, respectively, are given as [1, 2, 2]. The control device 20 may set the group of predetermined values [1, 2, 2] as the reference conditions of the etching device 1100 and the photo processing device 1200.

After the reference conditions are set as described above, OES data, PR coating speed RPM, and leveling data applied to a wafer introduced into the etching device 1100 and the photo processing device 1200 may be compared with the corresponding statistical data 1110, 1210, and 1220. The control device 20 may assign temporary eigenvalues z to the process parameters applied to the wafer introduced into the etching device 1100 and the photo processing device 1200, and the wafer characteristics of the corresponding wafer, by using Equation 1. In the embodiment of FIG. 12, the temporary eigenvalues z assigned to the wafer introduced into the etching device 1100 and the photo processing device 1200 are given as [1, 3, 2].

The control device 20 may compare the temporary eigenvalues z with the eigenvalues set as the reference conditions. According to this embodiment of the present disclosure, the temporary eigenvalues z assigned to the OES data and the leveling data are identical to the corresponding eigenvalues *, while the temporary eigenvalue z assigned to the PR coating speed RPM, is greater than the corresponding eigenvalue *. Accordingly, the control device 20 may determine that an error occurs in controlling the PR coating speed PRM in the etching device 1100 and the photo processing device 1200 having the eigenvalues [1, 2, 2] as the reference conditions, and may adjust the PR coating speed in the photo processing device 1200 to thereby prevent a reduction in yield rates.

As set forth herein, according to exemplary embodiments of the present disclosure, a process management system may compare statistical data relating to process parameters with process parameters applied to a reference wafer having a relatively high yield rate, assign eigenvalues to the process parameters applied to the reference wafer, and set a group of eigenvalues assigned to the process parameters as reference conditions, thereby managing the overall processes to provide excellent production yields in consideration of correlations between respective process flows and relevant process parameters.

While the present disclosure has been shown and described in connection with embodiments, it will be apparent to those skilled in the art that modifications and variations could be made without departing from the spirit and scope of the present disclosure as defined by the appended claims.

What is claimed:

1. A process management system, comprising:
a processing device configured to perform a semiconductor process on a plurality of wafers, the processing device controlled by a process parameter; and
a control device configured to acquire statistical data relating to the process parameter and configured to select a reference wafer from the plurality of wafers,
wherein the control device is configured to compare a respective process parameter used for the reference wafer with the statistical data and configured to set a reference condition for the process parameter.

2. The process management system of claim 1, wherein the processing device comprises a plurality of processing devices, and
at least one of the plurality of processing devices includes a sensor configured to determine wafer characteristic values for the plurality of wafers.

3. The process management system of claim 2, wherein the control device is configured to acquire statistical data relating to the wafer characteristic values for the plurality of wafers, compare a wafer characteristic value for the reference wafer with the statistical data relating to the wafer characteristic values for the reference wafer, and set a reference condition for the wafer characteristic values.

4. The process management system of claim 3, wherein the control device is configured to control operations of the plurality of processing devices based on the reference condition for the process parameter and based on the reference condition for the wafer characteristic values.

5. The process management system of claim 1, wherein the control device is configured to assign an eigenvalue to the process parameter used for the reference wafer based on a representative value and a degree of scattering of the statistical data, and configured to set the eigenvalue as the reference condition.

6. The process management system of claim 5, wherein the reference wafer comprises a plurality of reference wafers and the process parameter comprises a plurality of process parameters, and
the control device is configured to assign a plurality of eigenvalues to the plurality of process parameters used for each of the plurality of wafers.

7. The process management system of claim 6, wherein the control device is configured to generate respective groups of the eigenvalues by classifying the eigenvalues assigned to each of the plurality of process parameters as a single group, and is configured to calculate representative values of the groups of the eigenvalues to determine a group of the representative values as reference conditions.

8. The process management system of claim 5, wherein the control device is configured to assign a temporary eigenvalue to the process parameter used for a wafer introduced into the processing device, and is configured to compare the temporary eigenvalue with the eigenvalue, and is configured to adjust the temporary eigenvalue.

9. The process management system of claim 8, wherein the control device is configured to change the temporary eigenvalue to the eigenvalue when the temporary eigenvalue is less than the eigenvalue, and is configured to maintain the temporary eigenvalue when the temporary eigenvalue is greater than the eigenvalue.

10. The process management system of claim 8, wherein the control device is configured to calculate a difference between the temporary eigenvalue adjusted based on a result of comparing the temporary eigenvalue with the eigenvalue, and is configured to predict a yield rate of the wafer introduced into the processing device using the calculated difference.

11. The process management system of claim 10, wherein the control device is configured to control the processing device to discharge the wafer introduced into the processing device when the calculated difference is greater than a predetermined value.

12. The process management system of claim 8, wherein the control device is configured to adjust the process parameter when the temporary eigenvalue is greater than the eigenvalue.

13. The process management system of claim 1, wherein the control device is configured to select a wafer having a yield rate greater than a reference yield rate from among the plurality of wafers as the reference wafer.

14. The process management system of claim 1, wherein the process parameter includes at least one of temperature, pressure, gas flow amount, a rate of the gas flow, chuck temperature, RF power and OES (optical emission spectrometer) data, used to control the semiconductor process.

15. A process management device, comprising:
a communications unit coupled to a plurality of processing devices configured to perform semiconductor processes on a plurality of wafers controlled by process parameters; and
a calculation unit configured to calculate statistical data relating to the process parameters by acquiring the process parameters through the communications unit, and select a wafer having a yield rate greater than a reference yield rate from among the plurality of wafers as a reference wafer,
wherein the calculation unit is configured to compare the process parameters applied to the reference wafer with the statistical data relating to the process parameters to set reference conditions of the process parameters.

16. A semiconductor process management system, comprising:
a semiconductor process control device configured to select a reference wafer from among a plurality of semiconductor wafers fabricated using a semiconductor processing device included in a semiconductor process used to fabricate the plurality of semiconductor wafers, wherein the semiconductor process control device is configured to select the reference wafer based on statistical data gathered on a range of semiconductor process parameter values,
wherein the semiconductor processing device has a respective semiconductor process parameter that varies over a range of values in fabricating the plurality of semiconductor wafers;
wherein the semiconductor process control device is configured to compare a value of the semiconductor process parameter used to fabricate the reference wafer to the statistical data associated with the range of values of the semiconductor process parameter values to set a reference value of the semiconductor process parameter value.

17. The semiconductor process management system of claim 16 wherein the semiconductor process control device is further configured to acquire the statistical data from the semiconductor processing device.

18. The semiconductor process management system of claim 16 wherein the semiconductor processing device comprises a plurality of semiconductor processing devices, wherein at least one of the plurality of semiconductor processing devices includes a sensor configured to determine values of a characteristic of the plurality of wafers.

19. The semiconductor process management system of claim 16 wherein the parameter includes at least one of temperature, pressure, gas flow amount, a rate of the gas flow, chuck temperature, RF power and OES (optical emission spectrometer) data.

20. The semiconductor process management system of claim 16 wherein the semiconductor processing device and the semiconductor process control device are remote from one another.
